(19) United States
(12) Patent Application Publication
(10) Pub. No.: US 2015/0150091 A1
(43) Pub. Date: May 28, 2015

(54) ENABLING CONTENT PROTECTION AND MANAGEMENT OF ELECTRONIC MAIL

(71) Applicant: INTERNATIONAL BUSINESS MACHINES CORPORATION, Armonk, NY (US)

(72) Inventors: EDWIN J. BRUCE, CORINTH, TX (US); ROMELIA H. FLORES, KELLER, TX (US)

(73) Assignee: INTERNATIONAL BUSINESS MACHINES CORPORATION, Armonk, NY (US)

(21) Appl. No.: 14/088,608

(22) Filed: Nov. 25, 2013

(51) Int. Cl. H04L 29/06; H04L 12/58

(52) U.S. Cl. CPC H04L 63/101; H04L 51/12
USPC 726/4

(57) ABSTRACT

A content portion within an electronic mail (email) message can be identified. The email message can include a message envelope, a header and a body. The body can be a text and/or a binary data. The header can specify an email recipient. The email can be persisted within a data store of a computing device. A content container enclosing the content portion can be established within the email. The container can include an access control list (ACL) and/or a protection mask. The ACL can include recipients allowed/disallowed to access the content portion. The mask can declare an allowed and a disallowed action associated with the content portion. The email can be transmitted to a mail transfer/submission agent. The email can include the header and the body, where the body includes the container and the content portion.

### BACKGROUND

The present invention relates to the field of electronic mail systems and, more particularly, to enabling content protection and management of electronic mail.

With strides forward coming over the last couple of decades for content handling capabilities offered by electronic mail (email) systems, and through the use of Multipurpose Internet Mail Extensions (MIME) support for secure content handling, email security and message customization have been improved. However, problems and extra work still remain around delivering tailored messages generated from the same base document. While such challenges can be overcome through the preparation of multiple versions of a given email targeted to single persons and/or groups, this approach is inefficient and fraught with human errors. When an error occurs and this approach fails, sensitive information can be revealed to individuals not authorized to access that information.

Further, no present-day mechanism exists to prevent inline content and/or documents attached to email messages from being delivered to individuals not authorized to view those pieces. That is, email attachments and inline content subdivisions are always conveyed to all recipients assigned to the containing message, and cannot be discriminatingly and discretely conveyed to individual recipients. As an example, many times workers can receive email attachments from coworkers which reveal sensitive project information not intended for general group consumption. Additionally, authors of emails cannot track the transmission and propagation path of a sent email to be aware of recipients which may have received the same later, i.e., through forwarding. That is, control of an email transmission is outside the author's hands once the original message is initially sent.

### BRIEF SUMMARY

One aspect of the present invention can include a system, an apparatus, a computer program product, and a method for enabling content protection and management of electronic mail. Content portions within an electronic mail (email) message can be isolated and identified as individual and separate units. The message can include a containing “envelope”, a header and a body. The body may carry text and/or binary data. The header may specify recipient addressing and/or routing information. The email message may be persisted within a data store of a computing device. One or several “content containers” enclosing portions or all of the message contents may be established across the message. A content portion's individual container may be associated with an access control list (ACL) and/or a protection mask. The ACL may reference recipients allowed or disallowed to access the container's content. The protection mask may declare allowed and disallowed actions applying to the associated content. The resulting whole email message may be transmitted to a mail transfer/submission agent. The message may include its header and body, where the body includes containers and their “managed” content.

Another aspect of the present invention can include a method, a computer program product, an apparatus, and a system for enabling content protection and management of electronic mail. A customization engine can be configured to protect email content enclosed within a container. The protected content can be a portion of an email message body. The entire email message can include a message header and a message body. The message body may consist of any of text, embedded audio/video content, or file attachments. The complete email message may be persisted within a data store of a computing device. The data store may be able to persist all or any of container mappings, related settings, and associated “raw” email contents.

Yet another aspect of the present invention can include a computer program product that includes a computer readable storage medium having embedded computer usable program code. The computer usable program code can be configured to permit the assignment of an access control list (ACL) to at least one container within an email message. The container can enclose a content portion of the message. The email message may include a message header and message body. The “contained content” can be a portion of the message body. The applicable user interface can be an interface of a mail user agent executing on a computing device. An email recipient can be associated with the ACL of the container. The ACL can include a set of allowed recipients and/or a set of disallowed recipients. The overall email message with the at least one container and its associated access control list can be electronically transmitted to one or several recipients.

### BRIEF DESCRIPTION OF THE SEVERAL VIEWS OF THE DRAWINGS

FIG. 1 is a schematic diagram illustrating a set of scenarios for enabling content protection and management of electronic mail in accordance with an embodiment of the inventive arrangements disclosed herein.

FIG. 2 is a schematic diagram illustrating a method for enabling content protection and management of electronic mail in accordance with an embodiment of the inventive arrangements disclosed herein.

FIG. 3 is a schematic diagram illustrating a system for enabling content protection and management of electronic mail in accordance with an embodiment of the inventive arrangements disclosed herein.

FIG. 4 is a schematic diagram illustrating an interface for enabling content protection and management of electronic mail in accordance with an embodiment of the inventive arrangements disclosed herein.

FIG. 5 is a schematic diagram illustrating a set of interfaces for enabling content protection and management of electronic mail in accordance with an embodiment of the inventive arrangements disclosed herein.

FIG. 6 is a schematic diagram illustrating a set of interfaces for enabling content protection and management of electronic mail in accordance with an embodiment of the inventive arrangements disclosed herein.

### DETAILED DESCRIPTION

The present disclosure is a solution for enabling content protection and management of electronic mail. In the solution, a Multipart Internet Mail Extension (MIME) content type can be utilized to provide content protection of an email message. In one embodiment, a content type can function as a content container to enable compartmentalization of the message body content. In the embodiment, control information associated with the container can permit visibility control, message transmission control, and the like. In one instance, an email client can permit an email author to specify one or more content portions associated with a container. In the instance, the email client can allow recipient inclusion and/or exclusion attributes to a container enabling transmission control.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including object oriented programming languages such as Java, Smalltalk, C++ or the like and conventional procedural programming languages such as the “C” programming language or similar programming languages. The program code may execute entirely on a user's computer, partly on a user's computer, as a stand-alone software package, partly on a user's computer and partly on a remote computer or entirely on a remote computer or server. In the latter scenario, the remote computer may be connected to a user's computer through any type of network, including a local area network (LAN) or a wide area network (WAN), or a connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams and combinations of blocks in the flowchart illustrations and/or block diagrams can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

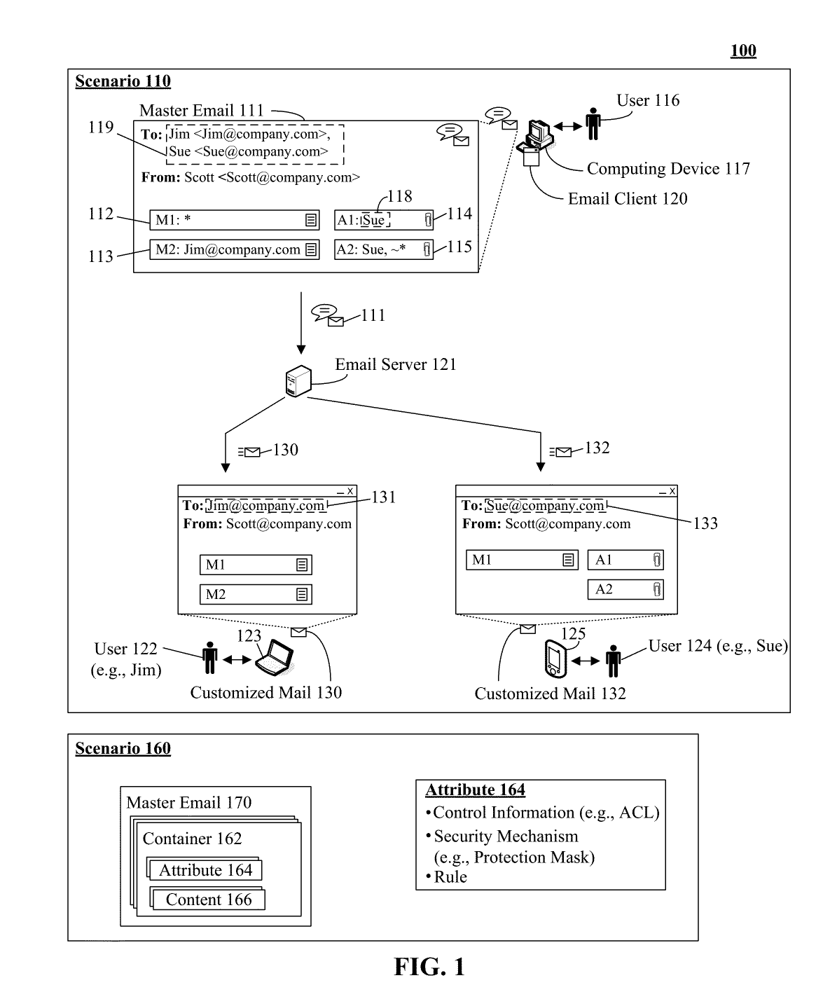

FIG. 1 is a schematic diagram illustrating a set of scenarios 110, 160 for enabling content protection and management of electronic mail in accordance with an embodiment of the inventive arrangements disclosed herein. Scenario 110, 160 can be present in the context of method 200, system 300, and/or interface 410, 510, 560, 610, 630 from the other figures. In scenario 110, a master electronic mail (email) 111 can be utilized to generate a customized email 130, 132 which can be conveyed to recipients 122, 124 and potentially consist of message portions M1 and M2 and/or attachments A1 and A2. In the scenario, a content target specifier 118 can be employed by user 116 to allow and/or restrict content 112-115 within email 111 to be accessed by recipients 122, 124. In scenario 160, an email container 162 can be utilized to securely personalize content 166 via attribute 164. Scenario 160 can represent an organizational scheme of email 170 which can be similar to that of email 111, 130, 132.

As used herein, an email client 120 can be a software program permitting the presentation and/or generation of a master email 111. For example, client 120 could be an IBM LOTUS NOTES email client program which can permit the composition of emails. Client 120 can be executed within computing device 117. Client 120 can be utilized to access an email mailbox associated with user 116. In one embodiment, an email mailbox can conform to an “mbox” format, a “maildir” format, and/or the like. Client 120 can permit user 116 to create master email 111 which could include but would not be limited to, user input (e.g., text input), file attachment selection, recipient selection 119, recipient assignment (e.g., specifier 118) to a portion of the email 111, and the like. For example, the user 116 can compose an email with an embedded video file. It should be understood that client 120 can manually and/or automatically communicate with a mail transfer/submission agent (e.g., server 121). For example, client 120 can communicate with email server 121 to send and receive email. It should be appreciated that client 120 can include traditional and/or proprietary functionality.

In one embodiment, client 120 can permit a content container to be associated with a content portion of email 111 (e.g., M1, M2, A1, A2). In the embodiment, the container can include an access control list (ACL) which can be utilized to permit or prohibit recipient access of content within the content container. It should be appreciated that the content container can be visually illustrated within scenario 110 as a rectangle enclosing one or more email body contents (e.g., M1, M2, A1, A2).

In scenario 110, a user 116 can utilize a computing device 117 to create a master email 111 via email client 120. Master email 111 and customized email 130, 132 can be digital text exchange messages associated with one or more recipients 119. Email 111, 130, 132 can include, but are not limited to, a message envelope, a message header, and a message body. The message header can include, but is not limited to, control information, an originator's email address (e.g., Scott@company.com), one or more recipient addresses 119 (e.g., sue@company.com, jim@company.com), and the like. It should be appreciated that the message header can be user established, automatically determined, and/or the like. For example, when a user 116 selects a “reply all” action within mail client 120, recipients 119 can be automatically determined and populated into mail 111 by mail client 120. It should be appreciated that a recipient 119 can include, but is not limited to an email address, a user identity, a canonical name, and/or the like.

A message body can include but is not limited to unstructured text, a signature block, and the like. In one instance, a message block can include one or more text sentences, text paragraphs (e.g., M1, M2), file attachments (e.g., A1, A2), and the like. For example, Scott can compose an email with a paragraph of information for Jim and Sue each (e.g., messages M1, M2) and two documents (e.g., attachments A1, A2) for Sue only.

In one embodiment, the disclosure can permit a user 116 to selectively include and/or omit portions of email 111 to be conveyed to recipients 122, 124 via container and/or container attributes (e.g., attributes 164). In the embodiment, each portion (e.g., M1, M2, A1, A2) can be associated with control information (e.g., email address) which can be employed to independently convey portions to an appropriate recipient. For example, a paragraph (e.g., message M2) within the email 111 can be conveyed to Jim as customized email 130 by associating the message M2 with the email address of Jim (e.g., Jim@company.com). It should be appreciated that multiple recipients can be associated with a portion of the email.

In one embodiment, a recipient can be associated with a portion of an email 111 via one or more content target specifiers 118. In the embodiment, the specifier 118 can be a text string which can identify a recipient by a canonical user identity (e.g., Sue) associated with a client 120 address book (e.g., contact list). In one instance, specifier 118 can include wildcard expressions and/or characters (e.g., “*”, “Sue, ˜*”). In the instance, specifier 118 can include an inclusion wildcard (e.g., “*”), exclusion wildcard (e.g., “˜*”), and the like. For example, an asterisk (e.g., “*”) can associate all recipients of email 111 with a portion of email 111 and a tilde and asterisk (e.g., “˜*”) can exclude all recipients of email 111 from a portion of email 111. In another example, an attachment 115 (e.g., A2) can be conveyed to Sue exclusively by associating a specifier “Sue, ˜*” 118 with the attachment. That is, Jim can be prohibited from receiving attachment A2. In one configuration of the embodiment, specifier 118 can include regular expressions.

Upon submission of email 111 by client 120, email server 121 can process email 111 utilizing one or more traditional and/or proprietary mechanisms. In one instance, server 121 can create customized mail 130, 132 from master email 111. In the instance, server 121 can utilize control information (e.g., specifier 118) to determine portions of email 111 which are associated with recipients. For example, email 130 which can include message M1, M2 can be conveyed to user 122 utilizing control information 131 and email 132 which can include message M1 and attachment A1, A2 can be conveyed to user 124 utilizing control information 133. In another instance, server 121 can utilize control information associated with content containers within email 111 to appropriately transmit mail 130, 132. In the instance, server 121 can perform one or more checks on container constraints (e.g., recipient addresses, specifier restrictions). Checks can include but are not limited to authorization checks, permission checks, and/or the like.

In one embodiment, server 121 can detect a Multipart Internet Mail Extension (MIME) content type and perform content type specific processing. In the embodiment, a MIME content type can be utilized to associate recipient addressing information (e.g., control information) with a content 112-115. In one instance, addressing information 131, 133 can be automatically populated based on control information (e.g., email address, canonical names, specifier 118) associated with content 112-115.

In one instance, a master email 111 can be utilized as a template for constructing customized email 130, 132. In the instance, master email 111 and customized email 130, 132 can conform to an organization similar to email 170.

In scenario 160, a master email 170 can include one or more content containers 162. Content container 162 can function as a wrapper which can compartmentalize content 166 within email 170. It should be appreciated that content 166 can include text paragraphs, text sections inherited from other emails, Uniform Resource Identifiers, Uniform Resource Locators (URLs), file attachments, embedded videos, embedded audio, and the like. Container 162 can include an attribute 164 and content 166 which can be utilized to perform the functionality described herein. In one instance, attribute 164 can include but is not limited to, control information (e.g., recipient addressing information, access control lists), a security mechanism, and/or a rule. That is, attribute 164 can be utilized to manage content 166 during and after initial email transmission. Security mechanisms can include but are not limited to, encryption, policy settings, protection masks, and the like.

In one embodiment, protection masks can be utilized to permit/deny actions associated with containers 162. In the embodiment, actions can include but are not limited to, a download action, a forward action, a reply action, a reply all action, and the like. Rules can include but are not limited to, presentation rules, transmission rules, and the like. It should be appreciated that the disclosure can utilize any traditional and/or proprietary (e.g., functionality described herein) content protection mechanism to enable arbitrarily complex content protection and/or management.

It should be appreciated that scenario 110, 160 illustrates a mechanism for enabling the disclosure functionality. In one instance, the disclosure functionality can be performed by embedding control information within email 111 and permitting an email client (e.g., client executing on device 123, 125) to perform the requisite presentation based on the control information. That is, email 111 can be identical to email 130, 132, but the presentation of content can vary based on content control information (e.g., permissions).

A key functionality within the disclosure includes opening, population of, and processing of targeting and access control information associated with individual containers enclosing portions of emails. The content payload can remain unmodified, while the containers carrying the payload would incorporate and/or transmit metadata associated with the conveyed payload. The metadata can be leveraged on the front end (e.g., outbound or client) and/or back end (e.g., inbound or server) of an email transaction and derivative transactions. That is, the disclosure permits a granular level of portion addressability carried, handled, and enforced by an email system without any adulteration of included content.

Drawings presented herein are for illustrative purposes only and should not be construed to limit the invention in any regard. It should be appreciated that devices 123, 125 can include executable email client software. It should be appreciated that email 111, 130, 132 can include descriptive information such as a subject header field, a message submission date/time stamp, and the like. It should be understood that wildcards associated with specifier 118 can be automatically and/or manually established. It should be appreciated that an arbitrary quantity of customized emails can be generated from a master email 111,170. It should be appreciated that master email 111 can be presented within email client 120 in a traditional and/or proprietary manner. It should be understood that the disclosure is not limited to utilizing specifiers 118 and can utilize any traditional and/or proprietary mechanism to achieve the functionality herein. It should be appreciated that the disclosure can support distribution list groups, contact list groups, and the like.

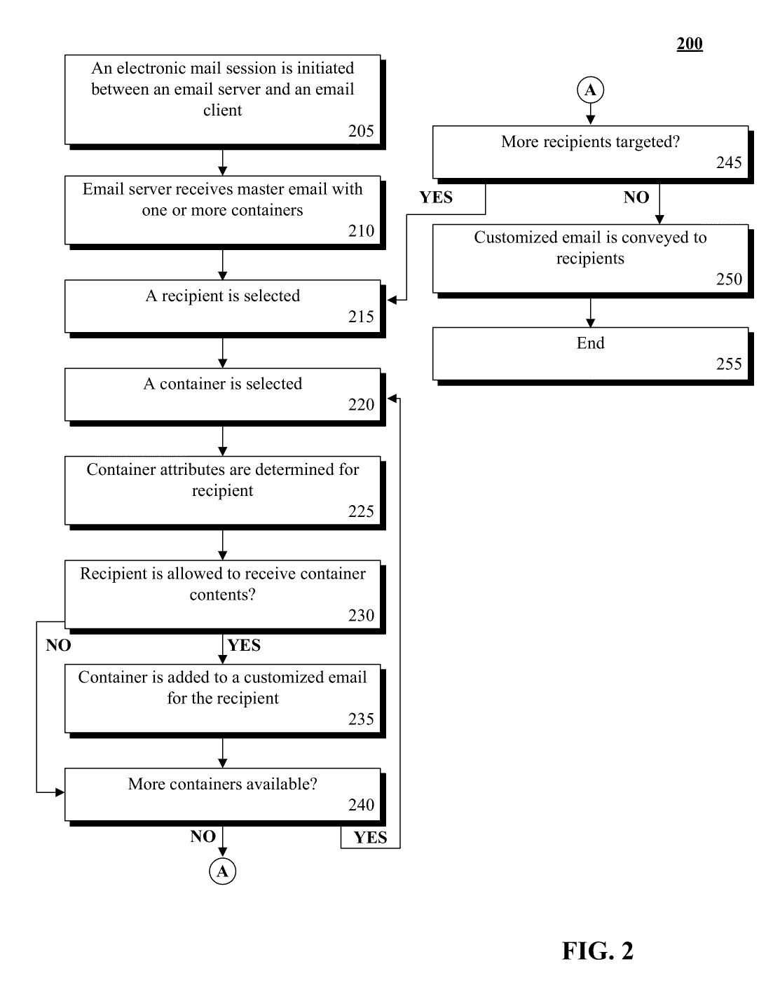

FIG. 2 is a schematic diagram illustrating a method 200 for enabling content protection and management of electronic mail in accordance with an embodiment of the inventive arrangements disclosed herein. Method 200 can be performed in the context of scenario 110, 160, system 300, and/or interface 410, 510, 560, 610, 630. Method 200 can be performed in serial and/or in parallel. In method 200, an electronic mail (email) can be configured to deliver customized content to recipients based on a container attribute.

In step 205, an electronic mail session can be initiated between an email server and an email client. In step 210, an email server can receive a master email with one or more containers. In one embodiment, the container can be established utilizing an Extensible Markup Language (XML) container. In step 215, a recipient targeted by the email can be selected. Selection can be performed based on recipient name, order of occurrence, and the like. In step 220, a container within the email can be selected. Selection can be performed based on container name, container identifier, and the like. In one instance, selection can be performed in alphabetical order, numerical order, and the like.

In step 225, the container attribute can be determined for the recipient. Container attributes can be determined utilizing traditional and/or proprietary mechanisms. For example, an attribute can be determined via keyword matching a content type with attribute values. In step 230, if the recipient is allowed to receive container contents, the method can continue to step 235, else it should jump to step 240.

In step 235, the container can be added to a customized email for the recipient. In one instance, an email with an email header addressed to the recipient and empty body can be generated. In the instance, each container associated with the recipient can be appended to the empty body creating a customized email for that recipient. In step 240, if more containers are available, the method can return to step 220, else continue to step 245. The method can be performed for each recipient and container associated with the subject email. In step 245, if more recipients are targeted, the method can return to step 215, else continue to step 250. In step 250, the customized emails can be conveyed to recipients. In step 255, the method can end.

Drawings presented herein are for illustrative purposes only and should not be construed to limit the invention in any regard. It should be appreciated that method 200 can include optional steps which can be omitted providing that the functionality of method 200 is retained. It should be understood that method 200 can include additional steps providing that the functionality of method 200 is retained.

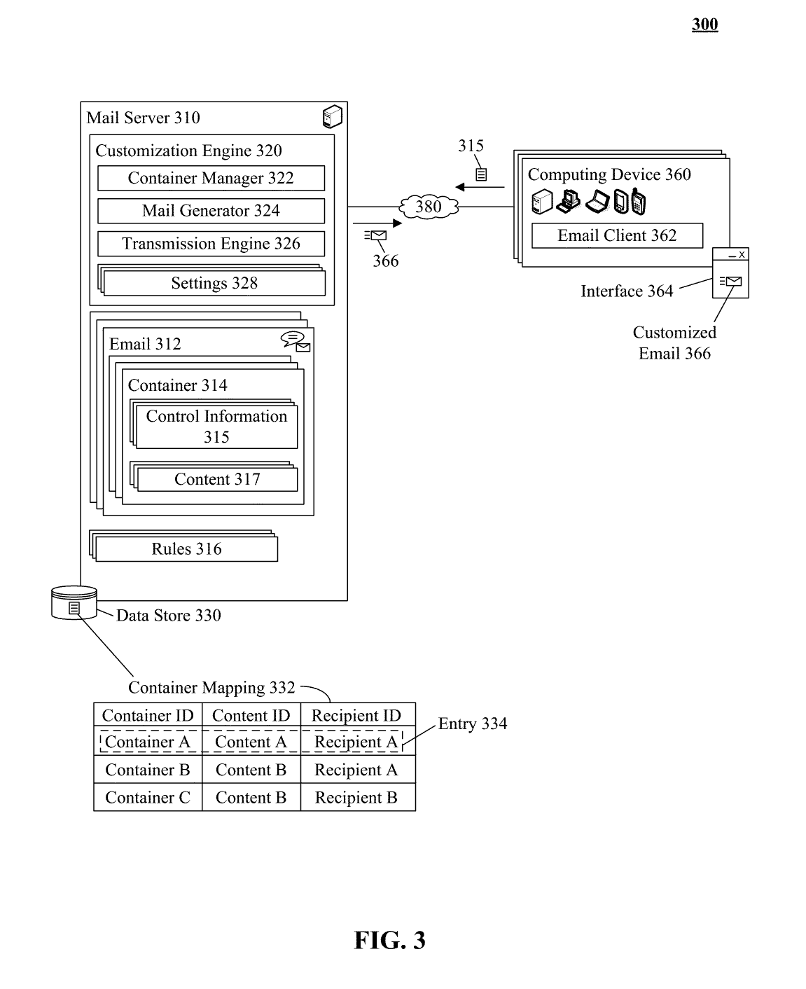

FIG. 3 is a schematic diagram illustrating a system 300 for enabling content protection and management of electronic mail in accordance with an embodiment of the inventive arrangements disclosed herein. System 300 can be performed in the context of scenario 110, 160, method 200, and/or interface 410, 510, 560, 610, 630. System 300 components can be communicatively linked via one or more networks 380. In system 300, a customization engine 320 can utilize control information 315 associated with a container 314 of an email 312 to generate customized email 366. Control information 315 and/or email 312 can be conveyed to engine 320. Engine 320 can produce an appropriate customized email 366 which can be transmitted to computing device 360.

Mail server 310 can be a hardware/software entity for executing engine 320. Server 310 functionality can include but is not limited to, store and forward functionality, encryption/decryption functionality, and the like. Server 310 can include but is not limited to, customization engine 320, text exchange 312, data store 330, and the like. In one embodiment, server 310 can include a mail transfer agent, message transfer agent, mail relay, mail exchanger, mail submission agent (MSA), a mail user agent (MUA), and the like. Server 310 capabilities can include but are not limited to SENDMAIL, POSTFIX, QMAIL, and the like. It should be appreciated that server 310 can utilize traditional and/or proprietary protocols. In one embodiment, server 310 can employ Simple Mail Transfer Protocol (SMTP), Post Office Protocol (POP3), Internet Message Access Protocol (IMAP4), and the like.

Customization engine 320 can be a hardware/software element for generating a customized email 366. Engine 320 functionality can include but is not limited to, mail 366 creation, mail 312 processing, proxy functionality, protection mask management, access control management, and the like. Engine 320 can permit email 312 creation, container 314 creation, and the like. In one instance, engine 320 can be a functionality of an email client 362. In one embodiment, engine 320 functionality can be delivered via a Service Oriented Architecture (SOA). In one instance, engine 320 can be a functionality of such as an IBM DOMINO MESSAGING SERVER.

Container manager 322 can be a hardware/software entity for managing one or more containers 314 within email 312. Manager 322 functionality can include but is not limited to, container presentation, container attribute management, container designation, and the like. In one instance, manager 322 can utilize container mapping 332 to enable customized email 366 generation from email 312. In the instance, mapping 332 can permit a content portion within a container to be encapsulated within a customized email 366. In one embodiment, manager 322 can utilize a container mapping 332 to track container content and/or container permissions. For example, entry 334 can be utilized to associate a recipient A with a content A of a container A, permitting only a recipient A to view content A.

Mail generator 324 can be a hardware/software element for generating customized email 366 based on control information 315. Generator 324 functionality can include but is not limited to, header population, content type designation, and the like. In one instance, generator 324 can perform wildcard substitution associated with specifiers (e.g., content target specifier 118). In one embodiment, generator 324 can create an appropriate message header and/or message body from control information 315 within container 314.

Transmission engine 326 can be a hardware/software entity for tracking and/or monitoring email 312. Engine 326 functionality can include but is not limited to, delivery confirmation, transmission tracking, and the like. In one embodiment, engine 326 can be utilized to track the conveyance of email 312 for each subsequent transmission after an initial transmission. In the embodiment, engine 326 can track recipients, quantity of transmissions, and the like. It should be appreciated that engine 326 can perform email address translation (e.g., domain to fully qualified domain name translation), user name translation, protocol addressing translation, and the like.

In one embodiment, engine 326 can provide instrumentation and/or reporting on the delivery of emails. In the embodiment, engine 326 can be utilized to support a customizable analytics dashboard which can be utilized to discover analytical dimensions. Dimensions can include fates of content sent, trends toward content usage, feedback paths, patterns of reuse, and the like. In one embodiment, engine 326 can facilitate visual manifestations of email transmission. For example, a “drill down” mapping can be able to depict the email travels and lifecycles of individual information entities.

Settings 328 can be one or more rules for establishing the behavior of system 300, server 310, and/or engine 320. Settings 328 can include but is not limited to, container manager 322 options, mail generator 324 settings, transmission engine 326 options, and the like. In one embodiment, settings 328 can be manually and/or automatically established. In one instance, settings 328 can be heuristically determined from historic settings. In one embodiment, settings 328 can be persisted within data store 330, computing device 360, and the like

Email 312 can be a text exchange message which can be conveyed to and from computing devices. Email 312 can be comprised of an American Standard Code for Information Interchange (ASCII) text format, binary data, and the like. Email 312 can include header information, container 314, and the like. In one instance, email 312 can include but is not limited to, a “From” field, a Date field, a Message-ID field, a In-Reply-To Message-ID field, a “To” field, a Subject field, a Blind Carbon Copy (BCC) field, a Carbon Copy (CC) field, a “Content-Type” field, a “Precedence” field, a “References” field, a “Reply-To” field, a Sender field, an “Archived-At” field, a Received field, a Return-Path field, an “Authentication-Results” field, and the like. It should be appreciated that email 312 can be associated with security mechanisms including but not limited to, encryption, a digital signature, and the like. In one instance, container 314 can be established utilizing a boundary attribute of a content type header.

Rules 316 can be one or more options for controlling content 317 transmission and/or presentation. In one embodiment, rules 316 can be manually and/or automatically established. It should be appreciated that rules 316 can complement control information 315. It should be understood that rule 316 and control information 315 conflicts can be resolved utilizing client 362 settings, user preferences, engine 320 settings, and the like. In one instance, rules 316 can conform to traditional and/or proprietary syntaxes. Rules 316 can be persisted within data store 330, device 360, email 312, and the like.

Data store 330 can be a hardware/software component able to persist container mapping 332, rules 316, email 312, and the like. Data store 330 can be a Storage Area Network (SAN), Network Attached Storage (NAS), and the like. Data store 330 can conform to a relational database management system (RDBMS), object oriented database management system (OODBMS), and the like. Data store 330 can be communicatively linked to server 310 via one or more traditional and/or proprietary mechanisms. In one instance, data store 330 can be a component of a Structured Query Language (SQL) compliant database.

Container mapping 332 can be one or more data sets for controlling and/or managing content 317. Mapping 332 can include but is not limited to, a container identifier, a content identifier, a recipient identifier, and the like. In one instance, mapping 332 can be manually and/or automatically established. In the instance, the mapping 332 can be automatically established based on historic email 312 and/or container 314 organization. In one instance, mapping 332 can be persisted within a mail server 310 data store, email 312, and the like.

Computing device 360 can be a software/hardware element for presenting email 312 and/or customized email 366. Device 360 can include, but is not limited to, input components (e.g., keyboard), output components 364 (e.g., display), client 362, interface 364, and the like. In one instance, interface 364 can be a Web based email interface (e.g., GMAIL). Device 360 hardware can include but is not limited to, a processor, a non-volatile memory, a volatile memory, a bus, and the like. Computing device 360 can include but is not limited to, a desktop computer, a laptop computer, a mobile phone, a mobile computing device, a portable media player, a PDA, and the like.

Network 380 can be an electrical and/or computer network connecting one or more system 300 components. Network 380 can include but is not limited to, twisted pair cabling, optical fiber, coaxial cable, and the like. Network 380 can include any combination of wired and/or wireless components. Network 380 topologies can include but are not limited to, bus, star, mesh, and the like. Network 380 types can include but are not limited to, Local Area Network (LAN), Wide Area Network (WAN), VPN and the like.

Drawings presented herein are for illustrative purposes only and should not be construed to limit the invention in any regard. It should be appreciated that one or more components within system 300 can be optional components permitting the disclosure functionality to be retained. It should be understood that engine 320 components can be optional components providing that engine 320 functionality is maintained. It should be appreciated that one or more components of engine 320 can be combined and/or separated based on functionality, usage, and the like. System 300 can conform to a Service Oriented Architecture (SOA), Representational State Transfer (REST) architecture, and the like.

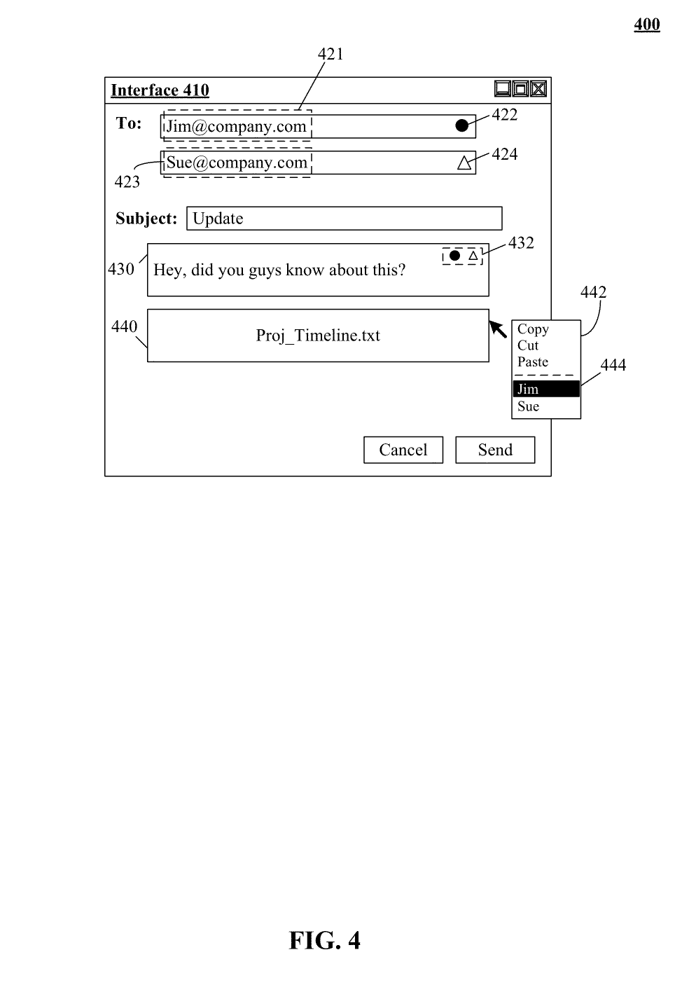

FIG. 4 is a schematic diagram illustrating an interface 410 for enabling content protection of electronic mail in accordance with an embodiment of the inventive arrangements disclosed herein. Interface 410 can be present in the context of scenario 110, 160, method 200, system 300, and/or interface 510, 610, 630. In interface 410, a context menu 442 can be utilized to selectively assign recipients to an attachment of an email. For example, an email client can permit a user to send an email attachment to one recipient of an email although the email is addressed to two recipients.

In one instance, interface 410 can present an organizational scheme which can permit rapid visual identification of containers and associated content. For example, sentence 430 and attachment 440 can each appear within a box which can represent two separate containers.

Interface 410 can be an email client which can permit the composition and/or transmission of an email. Interface 410 can include but is not limited to, one or more header field elements, a message body field element, an attachment selection/presentation element, and the like. In interface 410, a recipient 421, 423 can be specified within a recipient selection element (e.g., “To:” field) utilizing an email address (e.g., Jim@company.com). In one embodiment, recipient 421, 423 can be associated with a unique symbol 422, 424 which can be presented within the interface (e.g., proximate to the recipient). For example, content 430 can include an area surrounding the content which can include a symbol for each recipient; a circle symbol associated with a recipient Jim (e.g., Jim@company.com) and a triangle symbol associated with a recipient Sue (e.g., Sue@company.com).

In one instance, context menu 442 can be utilized to rapidly assign a recipient to a portion of an email within interface 410. For example, a context menu with the recipients 421, 423 can be presented upon selection of attachment 440. In one instance, a context menu can permit the selection of item 444 which can associate recipient 421 with attachment 440.

In one instance, interface 410 can permit traditional GUI selection such as point and click, click and drag (e.g., as multiple drawing objects are selected within presentation authoring applications), and the like. In the instance, the GUI selections can be utilized to create containers, assign recipients to containers, and the like.

In one embodiment, interface 410 can present a default quantity/arrangement of containers based on historical emails, user preferences, email client settings, and the like. In one instance, container creation can be performed automatically based on user interaction. In the instance, container creation can be trigged by paragraph creation (e.g., editing text), file attachment selection, signature appending, and the like.

It should be appreciated that container modification can be performed via one or more user interface options. Modification can include but is not limited to, container addition, container deletion, container merging, container splitting, and the like. In one embodiment, a context menu can present an option to merge two or more containers. In the embodiment, the control information (e.g., recipients) can be automatically merged utilizing one or more rules (e.g., rules 316).

Drawings presented herein are for illustrative purposes only and should not be construed to limit the invention in any regard. It should be appreciated that interface 410 can include traditional and/or proprietary user interface elements. In one embodiment, a context menu can permit the creation of a container. For example, when a content portion is selected (e.g., via highlighting), a context menu can be presented with an option to create a new container with no recipients assigned. In the embodiment, a container can be created by the selection of a highlighted content portion and the assignment of a recipient. It should be appreciated that symbols associated with the disclosure can be arbitrarily determined based on user selection, user preference settings, application settings, and the like. For example, symbols can include graphical icons (e.g., avatar icons), colors, special graphical effects, and the like.

In one embodiment, interface 410 can permit keyword tagging of content and/or containers which can facilitate the functionality described herein. In the instance, selection of a container can prompt for user input of a user name associated with a recipient. For example, selection of container 440 can present a pop-up dialog which can permit input of user names from a contact list associated with the interface 410. That is, users can quickly tag containers and/or content based on canonical names (e.g., Jim) associated with email addresses (e.g., Jim@company.com) of a contact list.

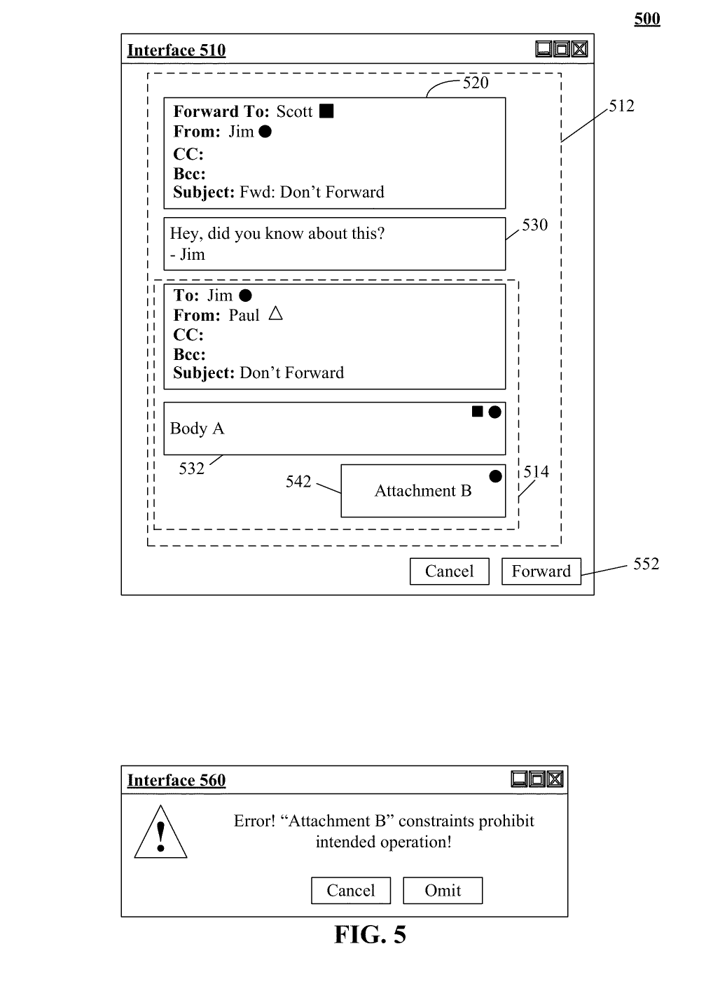

FIG. 5 is a schematic diagram illustrating a set of interfaces 510, 560 for enabling content protection of electronic mail in accordance with an embodiment of the inventive arrangements disclosed herein. Interfaces 510, 560 can be present in the context of scenario 110, 160, method 200, system 300, and/or interface 410, 610, 630. Interfaces 510, 560 can be one or more screens of an email client. Interfaces 510, 560 can illustrate content protection functionality associated with an email forward action.

In interface 510, an email 514 can be prepared within an email client to be forwarded by a user. For example, email 514 can be appended to email 512 during preparation. That is, header information and content 532, 542 can be included in email 512 (e.g., quoted). In one instance, interface 510 can present symbols proximate to a recipient to permit easy identification of recipient permitted content. For example, recipients Scott and Jim can be associated with a square and a circle. In one instance, interface 510 can permit forwarding email 514 via selection of forward interface button 552. In interface 510, a recipient Scott can be permitted to receive/view content 532, but be prohibited from receiving/viewing content 542. For example, this can be denoted by a square and a circle within an area surrounding content 532 and a circle within an area surrounding content 542.

Email 512 can be addressed to a recipient who conflicts with a constraint of a portion of email 514. For example, email 512 can be addressed to Scott who can be unauthorized to view attachment B. In one instance, interface 560 can be presented when a recipient of email 512 is specified who conflicts with control information associated with email 514. In one embodiment, when a content protection violation occurs, an interface 560 can be presented prior to email transmission selection. In the embodiment, when forward 552 interface button is selected and a content protection conflict occurs, interface 560 can be presented.

In interface 560, a notification can be presented permitting a user enacted action to be performed responsive to a content protection conflict. For example, interface 560 can present a notification indicating the content name and/or container name which is affected by the content protection conflict. In one instance, interface 560 can be a pop-up dialog which can permit a user to cancel the forward action or transmit the email 512 without content 542. For example, the notification can permit a user to transmit email 512 and omit an attachment B when the recipient of email 512 is not permitted to view the attachment, or alternatively, the notification can facilitate a return to editing of the email 512.

Drawings presented herein are for illustrative purposes only and should not be construed to limit the invention in any regard. Interface 560 is not limited to two user performable actions and can include an arbitrary quantity of user selectable actions. In one instance, interface 510, 560 can be a portion of a Rich Internet Application. It should be appreciated that the arrangement of interface 510, 560 is for exemplary purposes only and should not be construed to limit the invention in any regard.

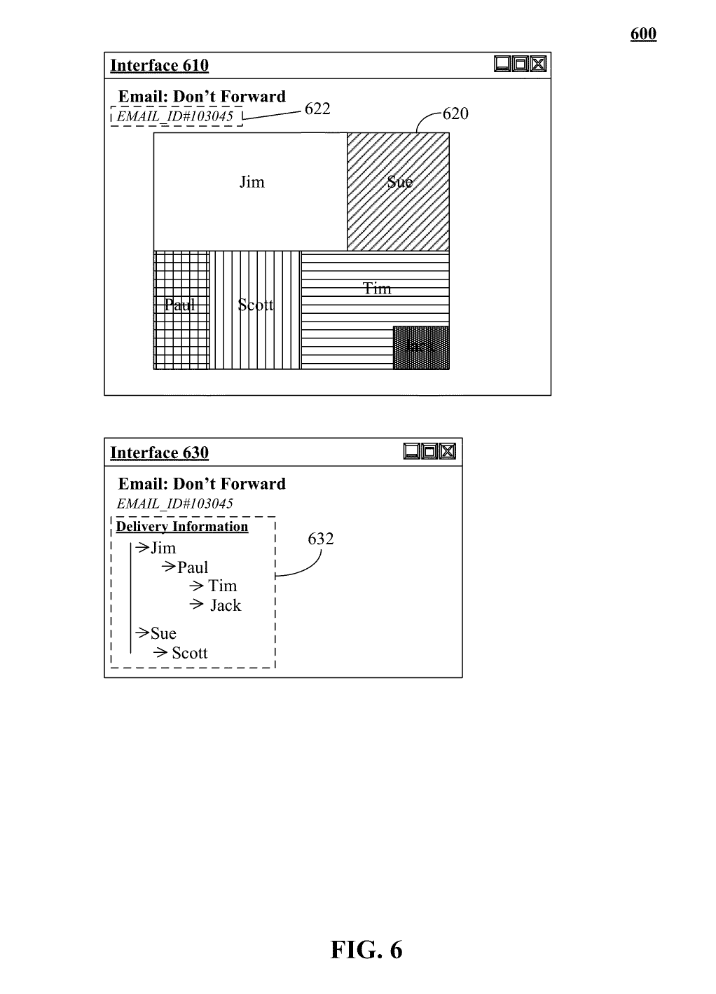

FIG. 6 is a schematic diagram illustrating a set of interfaces for enabling content protection of electronic mail in accordance with an embodiment of the inventive arrangements disclosed herein. Interfaces 610, 630 can be present in the context of scenario 110, 160, method 200, system 300, and/or interface 410, 510, 560. Interfaces 610, 630 can be one or more screens of an email client. In one instance, interfaces 610, 630 can be one or more screens of an administrative interface (e.g., dashboard).

In interface 610, a graphical display of an email transmission history can be presented. In one instance, interface 610 can present a heat map 620 of an email transmission based on recipient action (e.g., send, forward). Interface 610 can include an email identifier 622 associated with the graphical display, email header information (e.g., Subject), and the like. For example, interface 610 can present an email Subject, email identifier 622 and a graph of recipients 620 who received an email attachment associated with the email.

In interface 630, a graphical display of an email transmission history can be presented. In one instance, interface 630 can present a graphical hierarchy 632 of an email transmission history. Interface 630 can include an email identifier associated with the graphical display, email header information (e.g., Subject), and the like. For example, interface 630 can present an email Subject, email identifier and a graph of recipients who received an email attachment associated with the email.

Drawings presented herein are for illustrative purposes only and should not be construed to limit the invention in any regard. It should be appreciated that interface 610, 630 can include visualizations including but not limited to, graphs (e.g., pie charts), routing maps, and the like.

The flowchart and block diagrams in the FIGS. 1-6 illustrate the architecture, functionality, and operation of possible implementations of systems, methods and computer program products according to various embodiments of the present invention. In this regard, each block in the flowchart or block diagrams may represent a module, segment, or portion of code which comprises one or more executable instructions for implementing the specified logical function(s). It should also be noted that in some alternative implementations, the functions noted in the block may occur out of the order noted in the figures. For example, two blocks shown in succession may in fact be executed substantially concurrently, or the blocks may sometimes be executed in the reverse order, depending upon the functionality involved. It will also be noted that each block of the block diagrams and/or flowchart illustration and combinations of blocks in the block diagrams and/or flowchart illustration can be implemented by special purpose hardware-based systems that perform the specified functions or acts, or combinations of special purpose hardware and computer instructions.

1. A method for email content control comprising:
identifying a content portion within an electronic mail (email), wherein the email comprises of a message envelope, a message header and a message body, wherein the body is at least one of a text and a binary data, wherein the message header specifies at least one email recipient, wherein the email is persisted within a data store of a computing device;
establishing a content container enclosing the content within the email, wherein the container comprises of at least one of an access control list (ACL) and a protection mask, wherein the ACL comprises of at least one of a set of recipients allowed to access the content and a set of recipients disallowed access to the content, wherein the protection mask declares at least one of an allowed action and a disallowed action associated with the content; and
transmitting the email to at least one of a mail transfer agent and a mail submission agent, wherein the email comprises of the message header and the message body, wherein the message body comprises of the container and the content.

2. The method of claim 1, wherein the container is established via a Multipart Internet Mail Extension (MIME) content type metadata.

3. The method of claim 1, further comprising:
a user interface permitting the assignment of the access control list (ACL) to the container within an email, wherein the user interface is an interface of an mail user agent executing on a computing device; and
the user interface, associating the at least one email recipient with the ACL of the container.

4. The method of claim 1, further comprising:
detecting a metadata within the email defining a container enclosing the content of the message body of the email.

5. The method of claim 1, further comprising:
selectively conveying a container within an email to a recipient specified within the ACL of the container, wherein the recipient is allowed to access the content of the container.

6. The method of claim 1, wherein the container is defined by a content type boundary value, wherein the content type boundary value is a value of a Multipart Internet Mail Extension (MIME) content type.

7. The method of claim 1, further comprising:
detecting an action associated with the email not permitted by the protection mask; and
presenting a notification within an interface indicating the action is not permitted.

8. The method of claim 1, further comprising:
responsive to receiving the email, appending tracking data associated with the container to the email, wherein the tracking data is Simple Mail Transfer Protocol (SMTP) trace information.

9. The method of claim 8, further comprising:
presenting a visualization of the tracking data within an interface, wherein the visualization is at least one of a heat map, a graph, and a chart.

10. A system for email content control comprising:
a customization engine configured to protect an email content enclosed within a container, wherein the email content is a portion of an email message body, wherein the email comprises of a message header and a message body, wherein the message body is at least one of a text, an embedded audio/video content, and an attachment, wherein the email is persisted within a data store of a computing device; and
a data store able to persist at least one of a container mapping, a settings, and an email.

11. The system of claim 10, further comprising:
a container manager configured to assign at least one recipient specified in the message header to the container; and
a transmission engine configured to track the transmission path associated with at least one of the container and the email.

12. The system of claim 10, further comprising:
a mail generator able to assign a Multipart Internet Mail Extension (MIME) content type to the content, wherein the content type comprises of a content type identifier and a content type control information, wherein the control information is at least one of content transmission control information and presentation control information.

13. The system of claim 10, further comprising:
the transmission engine, appending tracking data associated with the container to the email, wherein the tracking data is Simple Mail Transfer Protocol (SMTP) trace information.

14. The system of claim 10, further comprising:
the transmission engine, presenting a visualization of the tracking data within an interface, wherein the visualization is at least one of a heat map, a graph, and a chart

15. The system of claim 10, further comprising:
the container manager configured to associate at least one of an access control list and a protection mask with the container.

16. The system of claim 10, further comprising:
the customization engine able to present an administrative dashboard, wherein the dashboard comprises of at least one of an email transmission trace and a container transmission trace.

17. The system of claim 10, further comprising:
the container manager configured to present at least one container attribute within an interface, wherein the manager is able to perform at least one container management action, wherein the action is at least one of a container creation, a container deletion, a container modification, a container splitting, and a container merging.

18. A computer program product comprising a user interface within a computer readable storage medium having computer usable program code embodied therewith, the computer usable program code comprising:
computer usable program code stored in a storage medium, if said computer usable program code of the user interface is executed by a processor it is operable to permit the assignment of an access control list (ACL) to at least one container within an email, wherein the container encloses a content of the email, wherein the email comprises of a message header and a message body, wherein the content is a portion of the message body, wherein the user interface is an interface of an mail user agent executing on a computing device;
computer usable program code stored in a storage medium, if said computer usable program code of the user interface is executed by a processor it is operable to associate at least one email recipient with the ACL of the container, wherein the ACL comprises of at least one of a set of allowed recipients and a set of disallowed recipients; and
computer usable program code stored in a storage medium, if said computer usable program code of the user interface is executed by a processor it is operable to transmit the email comprising of the at least one container and the access control list assigned to the at least one container.

19. The computer program product of claim 18, further comprising:
the user interface, identifying an email within an email mailbox, wherein the mailbox is associated with a user;
parsing the email to determine a plurality of containers within the message body of the email;
for each container of the plurality of containers, determining an ACL associated with the container;
when the recipient is permitted by the ACL to access the container, displaying the content associated with the container; and
when the recipient is not permitted by the ACL to access the container, not displaying the content associated with the container.

20. The computer program product of claim 18, further comprising:
for each recipient in the message header, comparing the recipient with the access control list of the container; and
when the recipient is not permitted by the ACL to access the content, presenting a notification indicating the recipient is not allowed to receive the container.
